(19) United States
(12) Patent Application Publication
(10) Pub. No.: US 2015/0228197 A1
(43) Pub. Date: Aug. 13, 2015

(54) Adaptive Learning Components for Electronic Books

(71) Applicants: Steven Victor McKinney, Ross, CA (US); Ron Severdia, San Anselmo, CA (US)

(72) Inventors: Steven Victor McKinney, Ross, CA (US); Ron Severdia, San Anselmo, CA (US)

(21) Appl. No.: 14/200,536

(22) Filed: Mar. 7, 2014

Related U.S. Application Data
(60) Provisional application No. 61/938,680, filed on Feb. 11, 2014.
(60) Provisional application No. 61/938,688, filed on Feb. 11, 2014.
(60) Provisional application No. 61/939,189, filed on Feb. 12, 2014.

(51) Int. Cl. G09B 5/02; G09B 19/00; G09B 7/00

(52) U.S. Cl. CPC G09B 5/02; G09B 7/00; G09B 19/00

(57) ABSTRACT

Adaptive learning components for electronic books and publications are provided herein. Methods may include receiving content selections from an end user, the content selections being obtained from content included in the electronic book, including the content selections into a virtual study container, determining descriptive metadata for the content selections in the virtual study container, generating an instructional learning component using the descriptive metadata determined from the content selections. The instructional learning component having instructional information that corresponds to the content selections included in the virtual study container, and displaying the instructional learning component within the electronic book.

### CROSS REFERENCE TO RELATED APPLICATIONS

This application claims the priority benefit of U.S. Provisional applications titled “ADAPTIVE LEARNING COMPONENTS FOR ELECTRONIC BOOKS”, Ser. No. 61/938,680, filed on Feb. 11, 2014, Ser. No. 61/938,688, filed on Feb. 11, 2014, and Ser. No. 61/939,189, filed on Feb. 12, 2014 which are hereby incorporated by reference herein in their entirety, including all references cited therein.

### FIELD OF THE TECHNOLOGY

Embodiments of the disclosure relate to electronic books and publications. More specifically, but not by way of limitation, the present technology provides adaptive learning objects within electronic books, such as quizzes, flashcards, games, and other similar informational/educational components. Electronic book readers may interactively identify or select content within the electronic book that is of interest to the reader. The present technology may create an adaptive learning component based upon the user selections and present this component to the reader as the reader uses the electronic book. Reader behavior and interactions with the learning component may be utilized to adaptively modify various aspects of the learning component.

### SUMMARY OF THE DISCLOSURE

According to some embodiments, the present technology may be directed to a method for providing an instructional learning component for an electronic book using a computing device. The method comprises: (a) receiving content selections from an end user, the content selections being obtained from content included in the electronic book; (b) including the content selections into a virtual study container; (c) determining descriptive metadata for the content selections in the virtual study container; (d) generating an instructional learning component using the descriptive metadata determined from the content selections, the instructional learning component comprising instructional information that corresponds to the content selections included in the virtual study container; and (e) displaying the instructional learning component within the electronic book.

According to other embodiments, the present technology may be directed to a system for providing an instructional learning component for an electronic book. The system comprises: (a) a processor; and (b) memory for storing executable instructions, the processor executing the instructions to: (i) receive content selections from an end user, the content selections being obtained from content included in the electronic book; (ii) place the content selections into a virtual study container; (iii) determine descriptive metadata for the content selections in the virtual study container; (iv) generate an instructional learning component using the descriptive metadata determined from the content selections, the instructional learning component comprising instructional information that corresponds to the content selections included in the virtual study container; and (v) display the instructional learning component within the electronic book.

According to additional embodiments, the present technology may be directed to a method for providing an electronic cooking guide using a computing device. The method comprises: (a) receiving an experience level for a cook; (b) receiving one or more preferred cuisine styles; (c) receiving a list of ingredients that are currently available to the cook; (d) generating a recipe for the cook using the experience level, the one or more preferred cuisine styles, and the list of ingredients that are currently available to the cook, the recipe including an ordered list of steps that are performed by the cook to successfully prepare the recipe; and (e) displaying, sequentially, the ordered list of steps for the cook.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates an exemplary system for practicing aspects of the present technology;

FIG. 2 is a flowchart of an exemplary method for providing an instructional learning component for an electronic book;

FIG. 3 is a flowchart of an exemplary method for adjusting an instructional learning component for a reader with disabilities;

FIG. 4 is a flowchart of an exemplary method for providing an electronic cooking guide using a computing device;

FIG. 5 illustrates an exemplary computing system that may be used to implement embodiments according to the present technology;

FIG. 6 is a screenshot of an exemplary user interface (UI) in the form of a super widget (e.g., instructional/adaptive learning component) that allows for the creation or editing of flash cards;

FIG. 7 is a screenshot of an exemplary UI in the form of another super widget that allows for modifications of an assessment such as a quiz;

FIG. 8 is another screenshot of the UI of FIG. 7 illustrating the selection of an auto-replace assessment, showing a dropdown box of selectable assessment themes;

FIG. 9 illustrates the addition of content into a virtual study container, the content being from an electronic publication and a video file;

FIG. 10 illustrates the generation of a flashcard widget using contents of the virtual study container;

FIG. 11 illustrates the generation of a flashcard widget using contents of the virtual study container, the flashcard widget comprising the video file that was placed into the container;

FIG. 12 illustrates an exemplary GUI for inputting criteria that can be used to create a recipe widget; and

FIG. 13 illustrates an exemplary GUI of a recipe widget that is based upon input received via the GUI of FIG. 12.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown in block diagram form only in order to avoid obscuring the disclosure.

Generally speaking, the present technology relates to the provision of adaptive learning components within electronic books, hereinafter referred to as “publications.” A publication may comprise any type of electronic document such as a book, a periodical, a playlist, a bulletin, a program, and/or a guide—just to name a few.

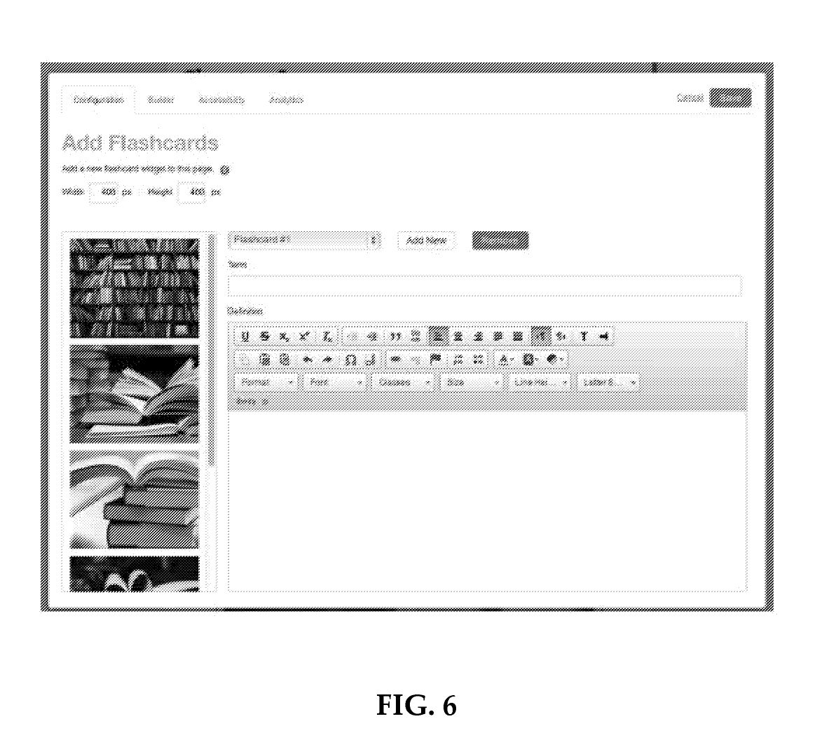

The present technology provides adaptive learning components such as quizzes, flashcards, games, a video, a graph, and so forth. In general, an adaptive learning component includes an interactive object that is used to convey instructional information to a reader. For example, flashcards may each include a display that comprises a question or prompt that is designed to test the reader's understanding of a topic. An opposing or subsequent display of the flashcard includes the correct answer to the question or prompt. Flashcards are utilized by a student as a drill to reinforce educational (e.g., informational) topics or content. An exemplary flash card generator widget (e.g., interactive object) is provided in FIG. 6. This widget may also be utilized to modify the content of a flash card. The UI may include a means for adjusting the width and height of the flash card by inputting pixel sizes for each value. Again, these may be adjusted automatically, based upon known information about the user, such as a physical or learning disability. The content of the flash card can be input manually using the text input box, or the content may be automatically fed into the text input box based upon previous content selections of the user.

While the above example contemplates a flashcard embodiment, the present technology may provide many other types of interactive objects such as quizzes, lists, games, videos, and so forth.

The creation and management of publications may occur at a central location such as a web server that publishes digital media publications. Likewise, the creation of adaptive learning components may occur on a web server, based upon reader interaction with the publication, as will be described in greater detail herein. The web server may provide the adaptive learning component to an end user computing device for display within the publication interface. For example, an e-reader application may display both a publication and an adaptive learning component associated with the publication. The web server may generated any of the publication and the adaptive learning component, while the e-reader application executing on the end user computing device (such as an e-reader device or other computing device that executes an e-reader application) displays the publication and the learning component.

In other embodiments, a downloadable program, plug-in, or module may execute on the client device (e.g., reader device) to allow readers to generate and display a publication, as well as create and provision adaptive learning components within the publication.

These and other advantages of the present technology will be described in greater detail with respect to the exemplary embodiments provided below.

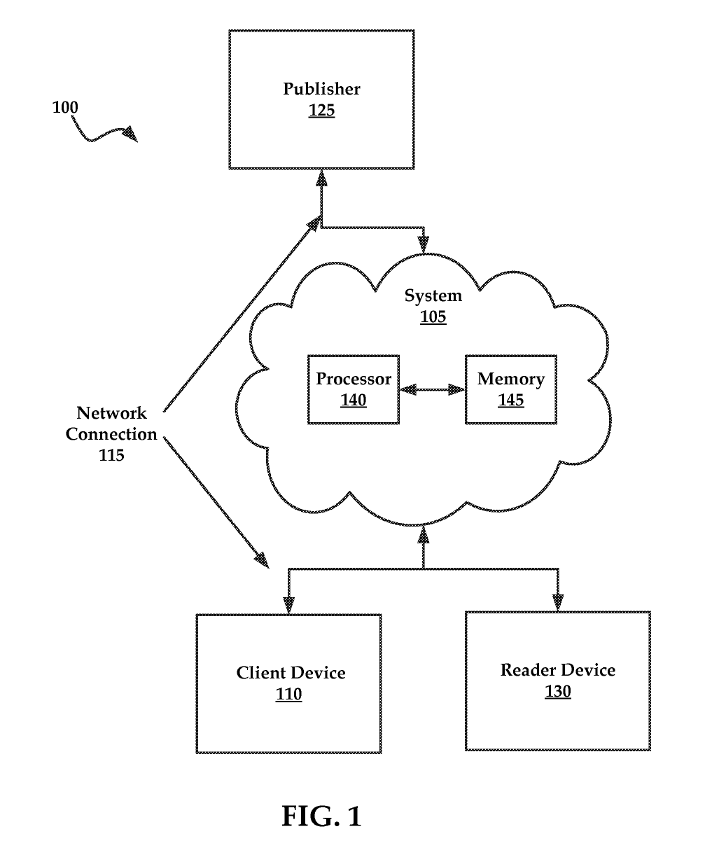

FIG. 1 illustrates an exemplary architecture 100 for practicing aspects of the present technology. The architecture 100 may include an adaptive learning component management system, hereinafter referred to as “system 105” that may be implemented in a web server or cloud-based computing environment. A cloud-based computing environment is a resource that typically combines the computational power of a large grouping of processors and/or that combines the storage capacity of a large grouping of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

In other embodiments, the system 105 may include a distributed group of computing devices such as web servers that do not share computing resources or workload. Additionally, the system 105 may include a single computing system that has been provisioned with a plurality of programs that each produces instances of event data.

Publication developers, publishers, instructors, or other third parties may access and interact with the system 105 via a client device 110 using a web-based interface, as will be discussed in greater detail infra. The system 105 may communicatively couple with the client device 110 via a network connection 115. The network connection 115 may include any one of a number of private and public communications mediums such as the Internet.

Additionally, the system 105 may publish personalized content, notifications, and the like to a third party social media platform, such as social media platform 120. In some embodiments, the system 105 may also publish or transmit publications to various third party distributors or publishers, such as a publisher 125. It will be understood that in some instances, the publications generated by the system 105 may be exported to, or stored in a storage media such as a content repository.

The system 105 may also communicatively couple with reader devices, such as reader device 130. The reader device 130 may comprise any of an e-reader, a tablet personal computer, a laptop, a mobile communications device, or any other computing device. As will be discussed in greater detail below, the reader devices 130 may each comprise a downloadable program, plug-in, or other executable instructions that allow individuals to personalize a publication by interacting with the reader device 130.

Again, the system 105 may communicatively couple with any of the client device 110 and/or reader device 130 via a public or private network 115. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 115 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

It will be understood that the generation of electronic documents is generally described in greater detail in co-pending U.S. patent application Ser. No. 13/355,451, which is hereby incorporated by reference herein in its entirety.

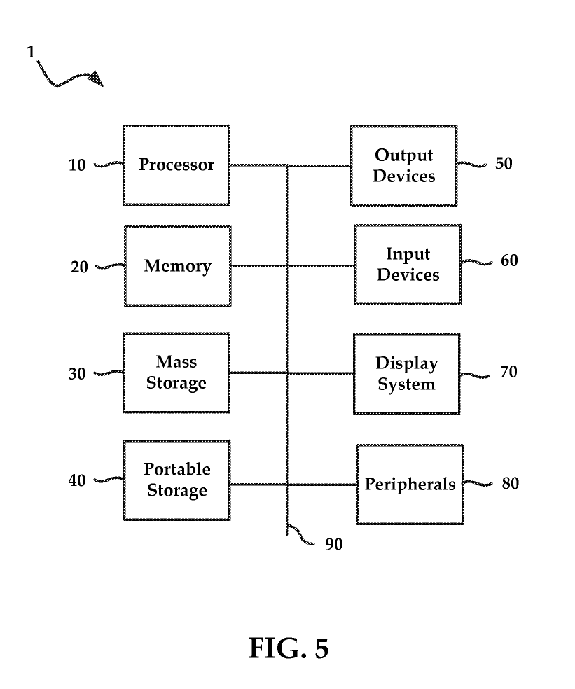

The system 105 may generally include a processor 140 and memory 145. The processor 140 may execute various instructions stored in memory 145 in order to perform methods described herein. For example, the processor 140 may execute instructions stored in memory 145 to provide an instructional learning component for an electronic book (e.g., publication). In other embodiments, the processor 140 may execute instructions stored in memory 145 to provide an electronic cooking guide, which adaptively creates a recipe for a cook. Again, these methods are merely exemplary and are not intended to be limiting in any way with respect to the present technology, which includes providing adaptive learning components. Additional components of the system 105 (as well as the reader device and client device) are described in more detail relative to FIG. 5, which is provided infra.

It will be understood that functionalities attributed to each of the system 105, client device 110, and reader device 130 individually may be combined into a single device, such as the reader device 130. That is, the functionality of the system 105 may reside within either the client device 110 or the reader device 130 in some instances.

Also, the methods executed by the system 105 may alternatively be executed solely by the reader device 130. Alternatively, the system 105 and reader device 130 may cooperatively execute various portions of the methods described herein. For example, computing intensive functions such as descriptive metadata analysis and instructional information gathering may be executed by the system 105, while information display and user input may occur via the reader device 130.

The adaptive learning components of the present technology utilize a modular code structure to input, process, manipulate and display content to the user. Data affecting these factors may include, but are not limited to (a) information collected from user input or history of input (with the current or other widgets); (b) information derived from user input or history of input (with the current or other widgets); (c) information in a database about the user (user capabilities, name, background, and so forth; (d) information determined from the context for content selections, including location within the publication, position within the publication (and relative to other content objects), and proximity to other content objects—just to name a few; (e) predefined parameters from the widget creator (such as instructor/author/publisher); and (f) information, media, or any other user input.

In some embodiments, a learning object of the present technology may have a display that includes the feedback/results of the processing of assigned information by the system 105. For example, the learning objects of the present technology may adapt to show correct/incorrect input, show alternate content, and show recommendations.

The adaptive learning components of the present technology may also be configured to generate content based on an algorithm using one or more factors, including games, puzzles, quizzes and other activities/exercises from collection define by user or content in current location. The following examples describe various adaptive learning objects used for various situations.

In one embodiment, the present technology may include a student activity learning widget, which comprises a quiz widget that is displayed in an electronic textbook to a student using a specified learning model. The student has difficulty answering the questions, getting 4 out of 5 incorrect. The quiz widget may adaptively present a number of options to the student including taking the quiz again. Alternatively, the widget may choose a different set of questions based on a different learning model derived from information about the user, the number of correct/incorrect responses, the ordering of selection or other factors, or any combinations thereof. The widget may be pre-programmed to choose one or more of these options via rules that are established by an educator, instructor, or other third party.

In another embodiment, the present technology may include a student helper activity widget that is displayed as a collection unit in an electronic student textbook. While the student reads, they drag in content selections such as snippets of text, images, video, URLs, and the like, that they are interested in, have questions about, or just want to generally learn more about. These content selections may be placed into a virtual study container maintained by the reader device. In some instances the virtual study container is maintained by the electronic publication. That is, the virtual study container may be embedded as a functionality within an electronic publication.

The widget will retrieve, derive, develop, or otherwise define descriptive metadata that classifies the content selections in a way that can be cross-referenced with each other or information stored on external sources. The external source information can be cross-referenced with a database of quizzes/activities based on type and number of available criteria to auto-generate those activities for the student. In sum, using the widgets/learning components of the present technology, students can engage in activities and tests based on their interests and specific aspects of the learning material included in the publication from which content selections are obtained.

In some embodiments, descriptive metadata for the content selections is further determined by inspection of a markup language utilized for the electronic book. For example, an inspection of XML documents for an electronic book may yield knowledge about a particular type of content. That is, markup language may specify an object type for one or more content objects included in the publication such as images, video, text, graphs, and so forth.

In an additional embodiment, the present technology may provide a cookbook recipe widget that is displayed in an electronic cookbook when selecting a recipe. Features of the cookbook recipe widget may allow for tracking of the purchasing of ingredients (and expiration dates thereof), cuisine preferences, historical recipe usage, preparation of ingredients prior to cooking, timing/coordinating, calories, and so forth.

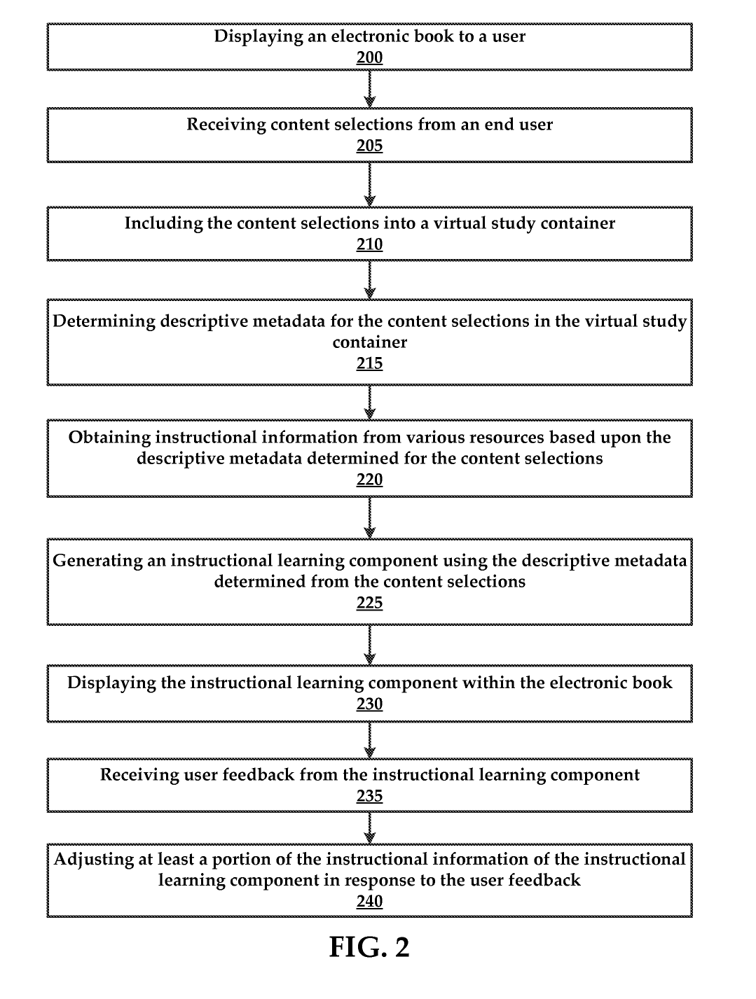

FIG. 2 is a flowchart of a method for providing an instructional learning component for an electronic book. Initially, the method may include displaying 205 an electronic book to a user. This may occur via a reader device, such as an e-book reader or other computing device that executes an e-book application. In other instances, the electronic book or publication may be provided by a web server that generates and displays a web-based e-book application/interface. For clarity, the remainder of the example will reference a reader device that provides a publication that includes an adaptive learning component of the present technology.

As the user reads content included in the publication, the content of the publication is displayed by the reader device so as to allow the reader to drag and drop content into a virtual study container. For example, the reader may highlight or select a portion of text, an image, a graph, a formula, or other similar content included in the publication. The reader may drag the content to the virtual study container in order to specify content that the reader would like to know more about, is confused by, or would like to place into a learning component of the present technology. Therefore, the method includes receiving 205 content selections from an end user. It will be understood that there may be any number of user interface paradigms to indicate the selection of content such as, selection or highlighting, clicking, option-clicking or keyboard shortcuts, or other similar user interactions.

Also, content placed into the virtual study container may include content for a publication that is currently being used by the reader. Further, the reader may upload, download, copy/past, move, or otherwise transfer other types of content into the virtual study container from any content source. For example, the reader may select content from a web page or a blog. The reader may build a virtual study container from selected content from a wide variety of resources. The present technology can be configured to create one or more instructional learning components from the content that is included in the virtual study container. The present technology may generate a learning component that comprises instructional information obtained for similar typed content that shares a common domain or subject matter. For example, the reader selections may all refer to US history, or another topic such as mathematics. Separate learning components may be created for each of the domains.

In other instances, the learning component may include instructional information for topics that are divergent in subject matter. Thus, only one learning component is created for the selections that are included in the study container.

According to one embodiment, the virtual study container comprises user interactions with previous segments or learning components of the electronic book. The virtual study container may include historical interactions from past sessions with the currently displayed electronic book or previously viewed electronic books, if these previously viewed books have content of a similar subject matter to the electronic book currently displayed. For example, user interactions with multiple electronic mathematics text books may be aggregated in the virtual study container, whereas interactions with both a mathematics text book and a humanities text book may be only marginally combinable, if at all.

Thus, in some embodiments, the method comprises including 210 the content selections into a virtual study container. The virtual study container may include, for example, a virtual folder or other data structure, such as a cache that receives the reader's content selections.

The method may further include determining 215 descriptive metadata for the content selections in the virtual study container. For example, if the content selection includes text, the descriptive metadata may include keywords included in the text or other information such as a domain (e.g., subject matter) that is deduced from the text. As mentioned above, the descriptive metadata allows for cross-referencing of a plurality of content selections in the virtual study container with one another and/or with information stored on external sources. For example, if content selections include text that is determined to include descriptive information about the Pythagorean theorem, the descriptive metadata for the content selections may include “Pythagorean theorem”, “triangles”, “geometry”, “algebra” or other similar metadata. This metadata will allow the system or reader device to search a network resource for additional information on these topics.

Again, it will be understood that information may not need to be obtained from a network resource. This information may be embedded in the publication itself or may otherwise be stored locally on the reader device.

In some instances, the method may include obtaining 220 instructional information from various resources based upon the descriptive metadata determined for the content selections. For example, the reader device or application may be configured to search the Internet for resources that correspond to descriptive metadata. In other instances, content repositories or databases may be searched or queried. The reader device or application may utilize an API (Application Programming Interface) or other protocol for searching network/online resources for information.

Once instructional information has been obtained, the method may include generating 225 an instructional learning component using the descriptive metadata determined from the content selections. As mentioned above, this may include searching for instructional information or populating the learning component with content that is available to the reader device/application.

Stated otherwise, the instructional learning component includes instructional information that corresponds to the content selections included in the virtual study container, as defined by the descriptive metadata. Metadata may also comprise descriptive metadata from the electronic book itself or may also include biographical metadata information about the user such as educational history, demographics, abilities, or economic status.

Once the instructional learning component (e.g., widget) is generated, the method includes displaying 230 the instructional learning component within the electronic book. In other embodiments, the learning component can be displayed at a later time or separately from the electronic book or document. For example, the widget may include flashcards that are provided to the reader during reading of the electronic book, or after the reader has completed reading a chapter or section of the electronic book.

Once initially generated and displayed to the reader, the instructional learning component may adapt to the needs of the reader. Thus, the method may include, in some embodiments, receiving 235 user feedback from the instructional learning component. For example, if the instructional learning component is a quiz, the reader may provide answers to questions included in the quiz. If the instructional learning component is a game, the reader may interact with the game. Thus, the feedback received is related to a goal associated with the instructional learning component. In some instances the goal may include learning a topic, achieving a certain level proficiency with regard to reading comprehension, mathematics, or any other educational endeavor.

Based upon feedback, the instructional learning component may be adapted/modified for various purposes. Adaptation or modification of the instructional learning component may occur in order to help the reader achieve the goal. For example, if the instructional learning component is a quiz, the reader may provide answers to specific questions. If the reader answers questions incorrectly, the instructional learning component may adapt to this failure by identifying the question that was answered incorrectly and display additional instructional information that helps the reader understand the question and answer. In one example the instructional learning component may play a video that explains the topic associated with the question in greater detail. Additionally, content associated with the question/answer pair may be displayed again to the reader.

The system 105 may track questions and responses, including whether questions were answered successfully. The system 105 may track this information for a single reader or for a plurality of readers, such as a student or a group of students in a class. Based upon feedback, the authors of the electronic book may determine that modifications to the content of the electronic book are warranted. For example, if the majority of students answer the same question(s) for a particular topic incorrectly, it may be inferred that the content associated with the topic has been presented in a manner that is unclear to the reader. Thus, the method may include allowing an instructor to modify the instructional information of the instructional learning component based upon user feedback from a plurality of users relative to a specific portion of the instructional information that has generated poor user feedback. The instructor or educator may further modify the instructional information of the instructional learning component as desired.

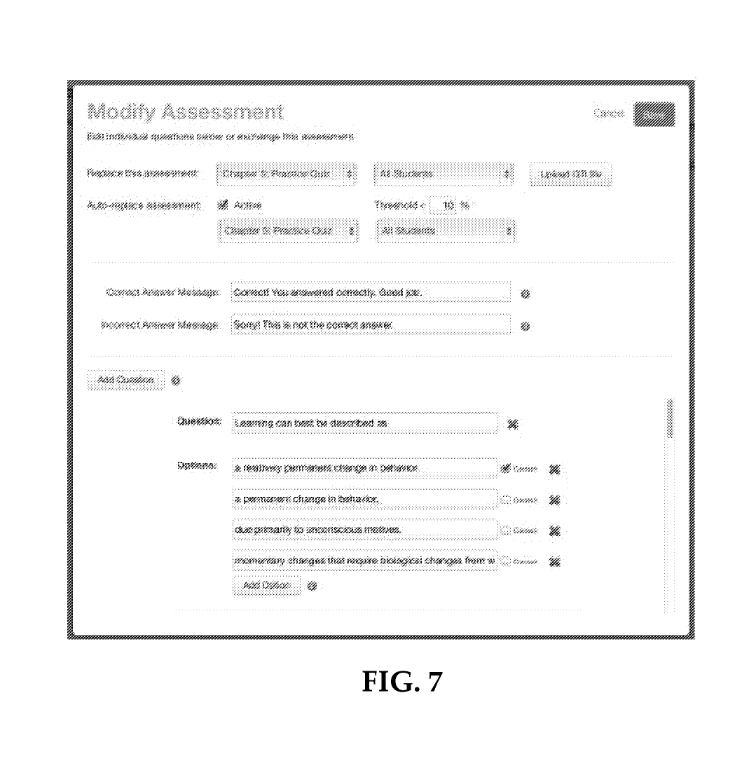

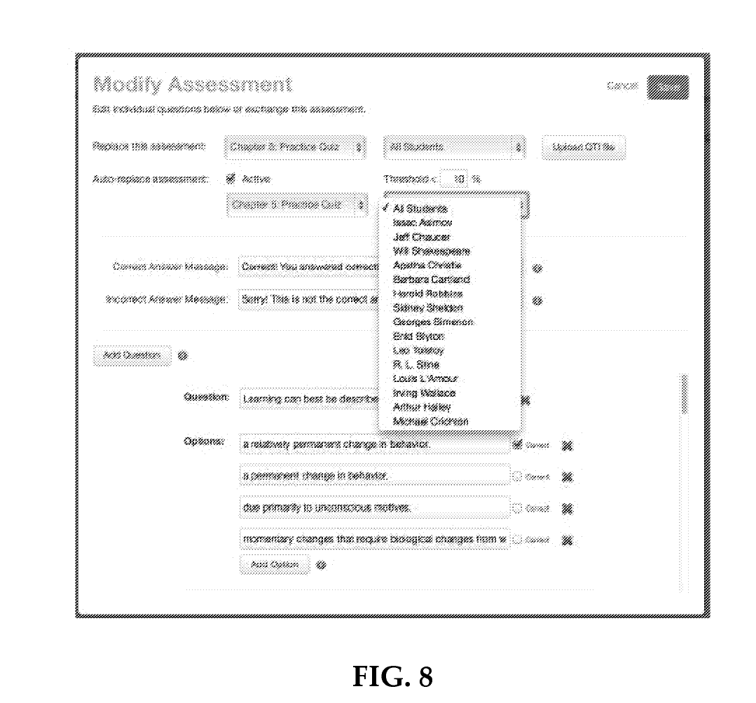

Exemplary UIs of widgets that are modifiable are illustrated in FIGS. 7 and 8 collectively. For example, a modifiable assessment may include questions and associated answers. The widgets may also include mechanisms that allow instructors to replace, either automatically or manually, various portions of the assessment. That is, the system 105 may automatically select or modify selectable objects, such as drop down boxes or text input boxes based upon user feedback or performance.

The system 105 may identify portions content in an electronic book that are associated with an instructional learning component and inform content authors of the reader feedback.

Thus, the method may include adjusting 240 at least a portion of the instructional information of the instructional learning component in response to the user feedback.

Alternatively, the method may include adjusting a visual appearance of the instructional learning component in response to the user feedback. That is, reader feedback may indicate that users prefer certain layouts for instructional learning components over others. For example, readers may decline to utilize certain types of instructional learning components and prefer to utilize other types of instructional learning components, even when these instructional learning components are based upon the same goal or task. By way of non-limiting example, a quiz layout may have a confusing visual appearance that makes reader interaction complicated or tedious. When the visual appearance is changed, an increase in use by reader is achieved. The system 105 may iteratively adjust the visual appearance of the instructional learning components to achieve a threshold level of participation. This threshold may be established by the content author or an instructor/educator.

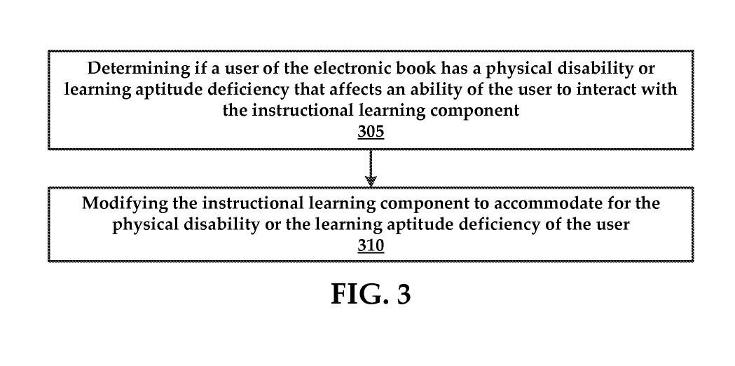

FIG. 3 is a flowchart of an exemplary method for adjusting or modifying an instructional learning component to accommodate for users with disabilities. The method may include determining 305 if a user of the electronic book has a physical disability that affects an ability of the user to interact with the instructional learning component. For example, feedback received from the user may indicate that the user is unable to successfully depress or select interactive objects such as buttons, check boxes, radio buttons, or other objects. A size of the objects may be small enough that a person with visual impairment or poor gross motor skills is unable to utilize the objects of the instructional learning component.

In other instances, display settings or other settings of the end user computing device (e.g., e-reader device) may identify that the user has a disability. For example, the user device may employ certain accessibility features such as a magnifying glass or a narrator.

If the user is determined to have a disability, the method may include modifying 310 the instructional learning component to accommodate for the physical disability of the user. For example, if the reader is visually impaired, the instructional learning component may be modified to utilize large buttons rather than selectable list items. Additionally, the font utilized may be increased from 12 to 18 point font.

As mentioned above, the instructional information for an instructional learning component may be determined, in part, based upon at least one of a location, a position, and proximity of the content selections relative to other content within the electronic book. For example, the importance of a content selection may be inferred from its position within the electronic book. Content that is important may often be placed prominently or earlier in the electronic book. Conversely, less important content may be placed further into the document or may be written in a smaller font. In some embodiments, key topic text may be displayed in callout bubbles or may be repeated at various locations within the document.

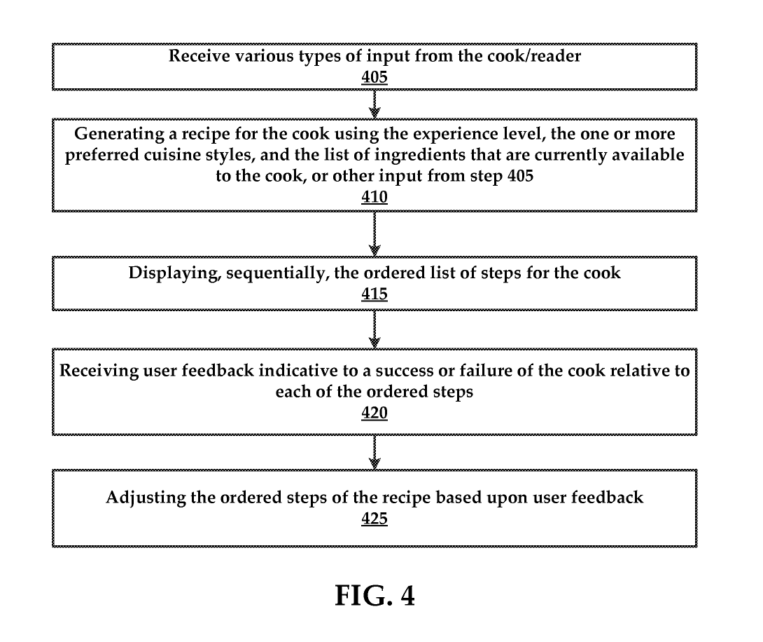

FIG. 4 is a flowchart of another exemplary embodiment of the present technology. More specifically, FIG. 4 illustrates a method for providing an electronic cooking guide using a computing device such as the system 105 or a reader device 130 (see FIG. 1). As with the examples above, for clarity, the following example will reference the reader device 130 that executes an e-reader application.

In some embodiments, the method of FIG. 4 is executed during display of an electronic cookbook to a reader (e.g., a cook). The e-reader application executing on the reader device 130 may be configured to receive 405 various types of input. For example, the reader device 130 may receive an experience level for a cook, one or more preferred cuisine styles, a list of ingredients that are currently available to the cook, a desired calorie count, and other similar criteria.

In some instances, the reader device 130 may determine best use dates or other time critical information regarding the ingredients in the list that are available to the cook. Advantageously, the reader device 130 can create recipes for the cook that account for the freshness and perishability of their available foods so as to prevent wasted products. The reader device 130 may create an ordered list of recipes that are ranked in order of importance, so as to maximize the use of the available ingredients and minimize waste. In some instances, the reader device 130 may calculate a best use date for each of the ingredients included in the list of ingredients that are currently available to the cook, and adjust the recipe in response to the best use dates for the ingredients

In some embodiments, the method includes generating 410 a recipe for the cook using the experience level, the one or more preferred cuisine styles, and the list of ingredients that are currently available to the cook, the recipe including an ordered list of steps that are performed by the cook to successfully prepare the recipe. In other embodiments, additional or fewer inputs may be utilized to create the recipe.

Next, the method includes displaying 415, sequentially, the ordered list of steps for the cook. This may include, for example, displaying steps that have a time frame associated therewith, such as “simmer onions for twenty minutes on low heat”. In some embodiments, steps may be executed in parallel. For example, the recipe may include a step of preparing another ingredient during the step of simmering onions, described above.

During display of the recipe, the method may include 420 receiving user feedback indicative to a success or failure of the cook relative to each of the ordered steps. For example, the cook may indicate that the onions were cooked for the proper amount of time. The cook may indicate that the onions appear to be properly cooked, or alternatively, do not appear to be properly cooked.

Feedback may be received from user input including typed text, natural language speech input, images obtained using the reader device, and the like. For example, the cook may take a picture of the onions after the step of simmering. The reader device may compare the picture of the simmered onions to a reference image to determine if the onions have been cooked long enough. By way of example, as onions cook they begin to change color. If the onion has not changed color it can be inferred that the onions are not sufficiently cooked.

In response to feedback, the method may include adjusting 425 the ordered steps of the recipe based upon user feedback. For example, if the cook indicates that the onions appear not to be thoroughly cooked, the recipe step of simmering onions may be adjusted to add additional time to the step. In some instances, the adjustment may include adjusting the ingredients used in the steps of the recipe or the total number of steps based on the criteria.

FIG. 5 illustrates an exemplary computing device 1 that may be used to implement an embodiment of the present systems and methods. The computing system 1 of FIG. 5 may be implemented in the contexts of the likes of clients, web servers, reader devices, computing devices, terminals, networks, or combinations thereof. The computing device 1 of FIG. 5 includes a processor 10 and main memory 20. Main memory 20 stores, in part, instructions and data for execution by processor 10. Main memory 20 may store the executable code when in operation. The system 1 of FIG. 5 further includes a mass storage device 30, portable storage device 40, output devices 50, user input devices 60, a display system 70, and peripherals 80.

The components shown in FIG. 5 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 5. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 5 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device. Peripherals 80 may include any type of computer support device to add additional functionality to the computing system. Peripherals 80 may include a modem or a router.

The components contained in the computing system 1 of FIG. 5 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

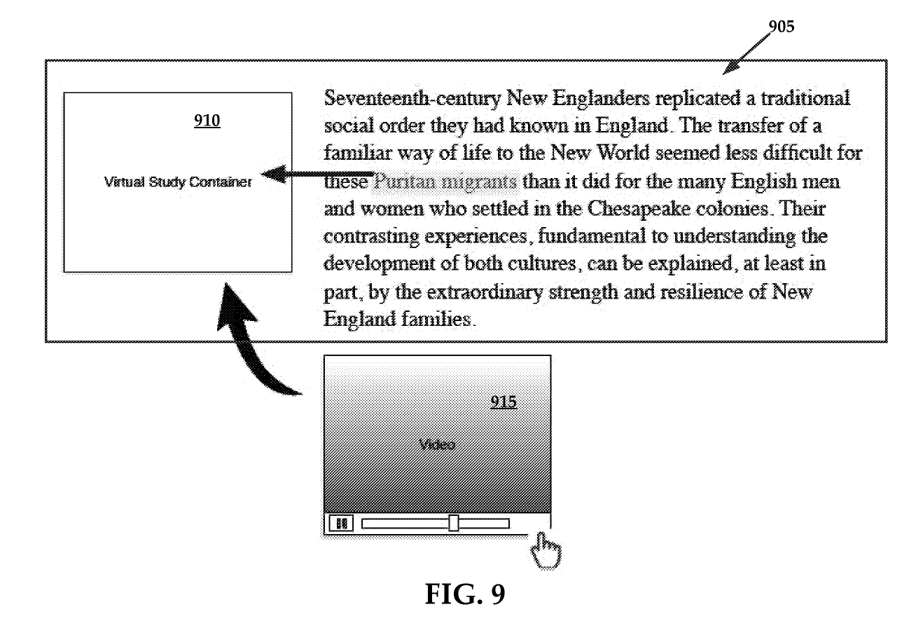

FIG. 9 illustrates a section 905 of an electronic publication (e.g., e-book). This section 905 includes textual content related to a historical event, such as might be found in a history text book. The reader may select the text phrase “Puritan Migrants” and drop the same into a virtual study container 910. The virtual study container 910 may be illustrated as a box or visual display for the reader. Also, a video file 915 may be dragged into the virtual study container. The “dragging” of the video might also include a copying of a URL or URI associated with the video file, rather than the video file itself. The video file may relate to the same (or even different) subject matter as the textual content in the section 905.

The system 105 will evaluate the content placed into the container 910 and can determine a domain for the content included therein. The system 105 can use the keywords in the selected phrase and search for other similar content related to “puritan migrants”. The system 105 may use natural language processing and/or examine metadata associated with the video file 915 to locate additional instructional information related to the video.

It will be understood that while the section 905 may be part of an electronic publication, the video file 915 may be found on a website, for example. Alternatively, the textual content and video may be included in the same electronic publication.

The placement of textual content and video file may occur during a single user session. Alternatively, the virtual study container may be populated over several sessions. For example, the reader may populate the container 910 with choices or selections from several different electronic text books while the user is completing homework tasks. The learning component may be compiled after the reader has filled the container with selections from many different books.

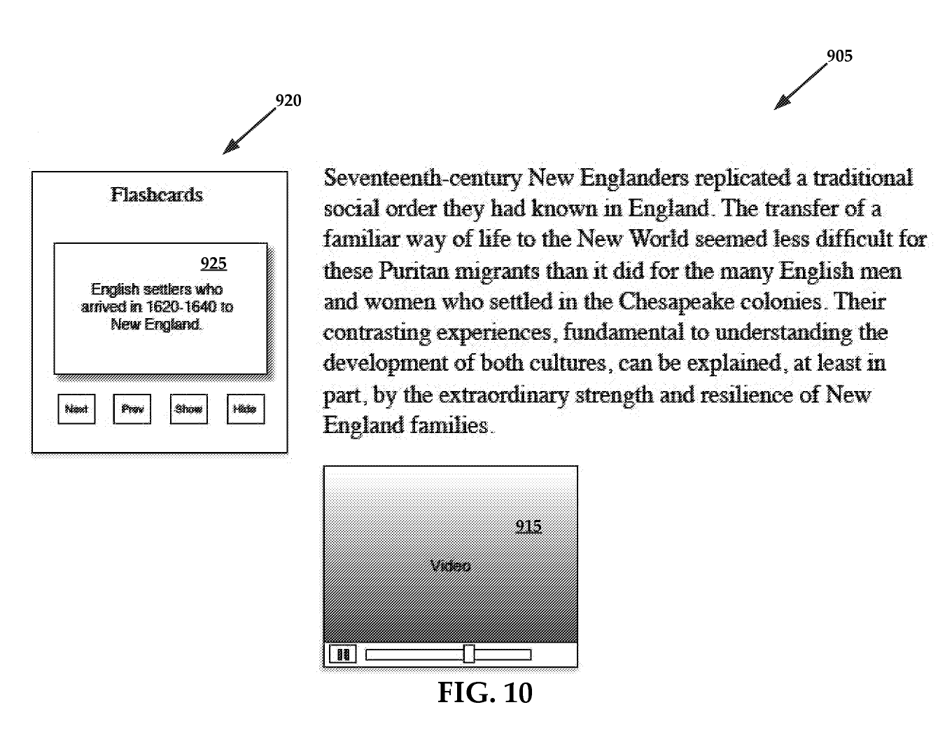

FIG. 10 illustrates an exemplary adaptive learning component 920 that has been created from the textual content “Puritan migrants”. For example, the system 105 may locate instructional information 925, such as a fact phrase or definition “English settlers who arrived in 1620-1640 to New England.” This instructional information is added to a flashcard widget (learning component 920). The reader may use navigational controls to traverse through additional instructional information, if any.

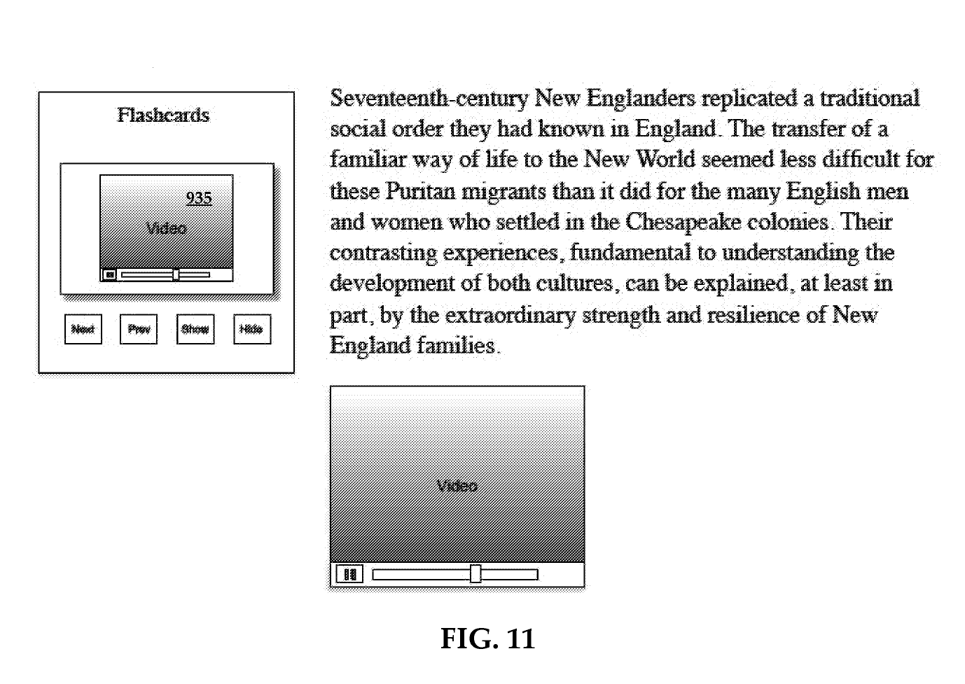

FIG. 11 illustrates another exemplary learning component 920 that includes another video file 925 that was selected in response to reader selections placed into a virtual study container.

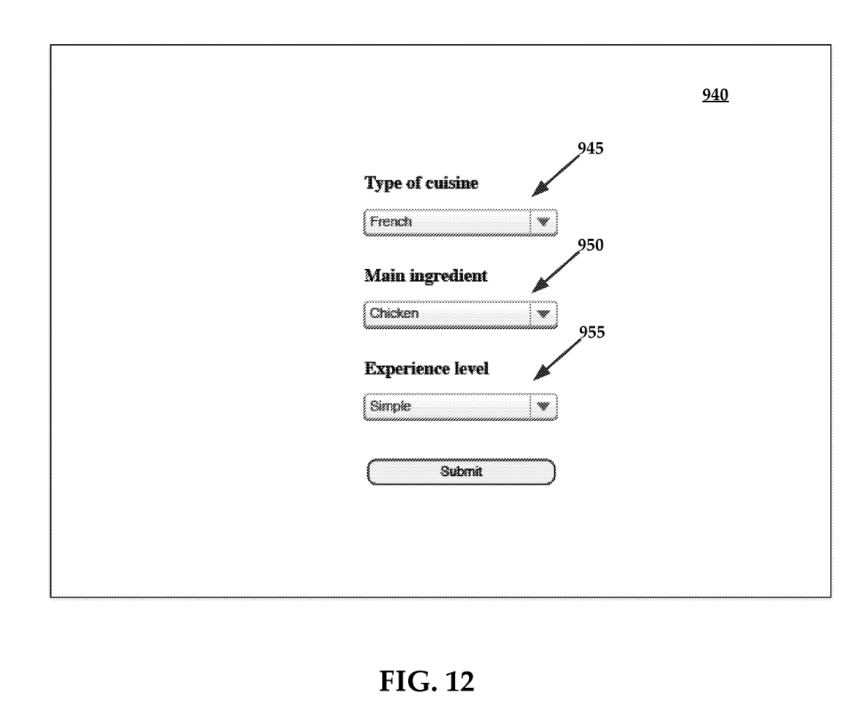

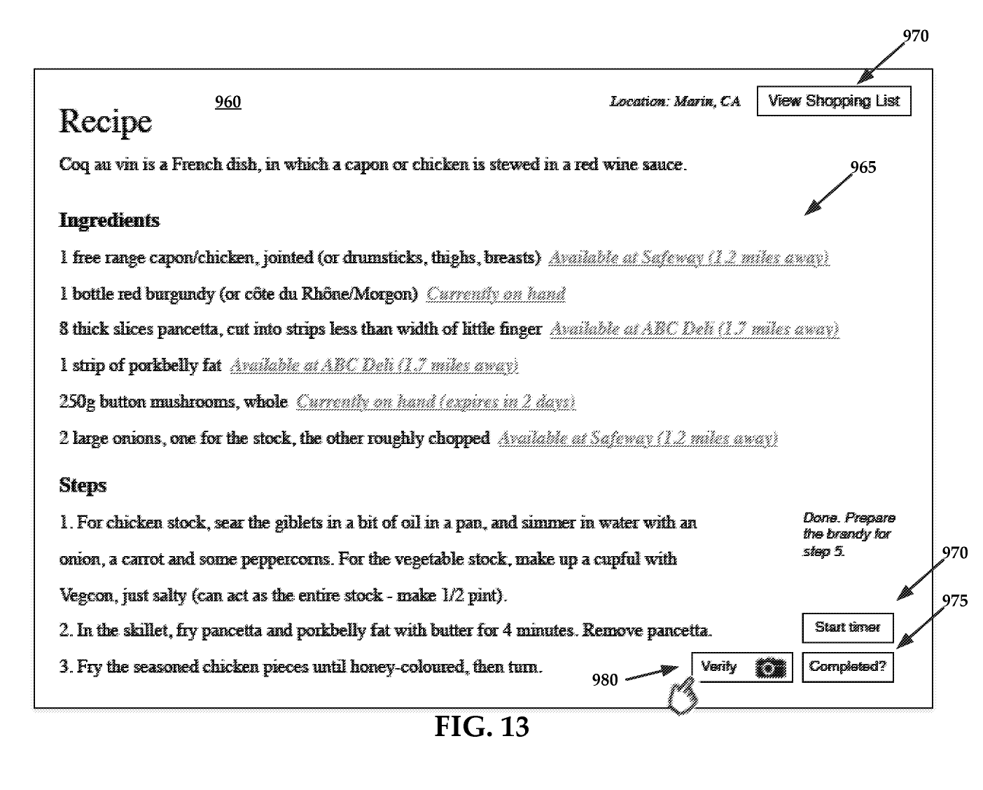

FIG. 12 illustrates an exemplary recipe GUI 940 that causes the system 105 to generate an interactive and informative recipe as shown in FIG. 13. The GUI 940 includes input mechanisms that allow the cook to select a type of cuisine 945, a main ingredient 950, and an experience level 955. Other similar variables related to preferences or cooking acumen may be used in addition to, or in lieu of those illustrated.

With the input defined, the system 105 may output an adaptive instructional component 960 of FIG. 13. The recipe 960 may comprise a list of steps 965 as well as a button 970 that when activated causes the system 105 to compile and display a shopping list for the recipe. The cook may specify their supplies that are on hand. The system 105 may combine this knowledge with the known list of ingredients and identify ingredients in the list that need to be purchased. For items in the list that the cook does not have on hand, the system 105 may specify where the item can be purchased. The system 105 may also identify ingredients that are on hand but are currently about to exceed a best use or expiration date. Again, the cook may specify these dates by logging in items into the system 105 or the system may infer these dates from a purchase date, if known.

The GUI 960 may include a button 970 that allows the cook to begin a timer, a button 975 that signifies completion of a current step, and/or a button 980 that verifies that a step has been completed. For example, the cook may depress button 980, which causes the reader device to execute a camera function. The cook can take a picture, which is compared by the system 105 against other baseline images. For example, the cook may take a picture of diced onions. The system 105 may compare the size of the dice to pictures of properly diced onions and identify whether the cook has diced the onion to a proper size. If not, the system 105 may display a video or image that instructs the cook as to how to properly dice an onion.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for providing an instructional learning component for an electronic book using a computing device that comprises a processor and memory for storing executable instructions, the processor executing the instructions to perform the method, comprising:
receiving content selections from an end user, the content selections being obtained from content included in the electronic book;
including the content selections into a virtual study container;
determining descriptive metadata for the content selections in the virtual study container;
generating an instructional learning component using the descriptive metadata determined from the content selections, the instructional learning component comprising instructional information that corresponds to the content selections included in the virtual study container; and
displaying the instructional learning component within the electronic book.

2. The method according to claim 1, further comprising receiving user feedback from the instructional learning component.

3. The method according to claim 2, further comprising adjusting at least a portion of the instructional information of the instructional learning component in response to the user feedback.

4. The method according to claim 2, further comprising adjusting a visual appearance of the instructional learning component in response to the user feedback.

5. The method according to claim 1, wherein the instructional learning component comprises any of an educational game, a quiz, a puzzle, an activity, an exercise, media, or any combinations thereof.

6. The method according to claim 1, further comprising determining if a user of the electronic book has a physical disability or a learning aptitude deficiency that affects an ability of the user to interact with the instructional learning component; and modifying the instructional learning component to accommodate for the physical disability or the learning aptitude deficiency of the user.

7. The method according to claim 6, wherein determining if a user of the electronic book has a physical disability includes inspecting display setting of the computing device.

8. The method according to claim 1, wherein the virtual study container comprises user interactions with previous segments or learning components of the electronic book.

9. The method according to claim 1, further comprising allowing an instructor or a third party to further modify the instructional information of the instructional learning component.

10. The method according to claim 9, further comprising obtaining instructional information obtained from any of a content repository, a database, a network resource, and combinations thereof.

11. The method according to claim 10, wherein instructional information includes descriptive metadata that has been matched to the descriptive metadata of the content selections included in the virtual study container.

12. The method according to claim 1, wherein the instructional information is determined, in part, based upon at least one of a location, a position, and proximity of the content selections relative to other content within the electronic book.

13. The method according to claim 1, wherein the instructional information is determined from user behaviors relative to interactive objects included in the electronic book.

14. The method according to claim 13, wherein the descriptive metadata for the content selections is further determined by inspection of a markup language utilized for the electronic book.

15. The method according to claim 1, further comprising allowing an instructor to modify the instructional information of the instructional learning component based upon user feedback or responses from one or more users relative to a specific portion of the instructional information that is has generated poor user feedback or responses.

16. The method according to claim 1, further comprising evaluating historical information collected or derived from user feedback and user behaviors of a user, the historical information being utilized to create the instructional information of the instructional learning component.

17. The method according to claim 1, further comprising evaluating user information of a user, which includes any of user capabilities, name, background, accessibility, disabilities, education level, and combinations thereof.

18. The method according to claim 1, further comprising displaying the electronic book to the user prior to receiving the content selections.

19. A system for providing an instructional learning component for an electronic book, the system comprising:
a processor; and
memory for storing executable instructions, the processor executing the instructions to:
receive content selections from an end user, the content selections being obtained from content presented to a reader by the system;
place the content selections into a virtual study container;
determine descriptive metadata for the content selections in the virtual study container;
generate an instructional learning component using the descriptive metadata determined from the content selections, the instructional learning component comprising instructional information that corresponds to the content selections included in the virtual study container; and
display the instructional learning component via the system.

20. The system according to claim 19, wherein the processor further executes the instructions to receive user feedback from the instructional learning component.

21. The system according to claim 19, wherein the processor further executes the instructions to adjusting at least one of:
at least a portion of the instructional information of the instructional learning component in response to the user feedback; and
a visual appearance of the instructional learning component in response to the user feedback.

22. A method for providing an electronic cooking guide using a computing device that comprises a processor and memory for storing executable instructions, the processor executing the instructions to perform the method, comprising:
receiving an experience level for a cook;
receiving one or more preferred cuisine styles;
receiving a list of ingredients that are currently available to the cook;
generating a recipe for the cook using the experience level, the one or more preferred cuisine styles, and the list of ingredients that are currently available to the cook, the recipe including an ordered list of steps that are performed by the cook to successfully prepare the recipe; and
displaying, sequentially, the ordered list of steps for the cook.

23. The method according to claim 22, further comprising receiving user feedback indicative to a success or failure of the cook relative to each of the ordered steps.

24. The method according to claim 22, further comprising adjusting the ordered steps of the recipe based upon user feedback.

25. The method according to claim 22, further comprising calculating a best use date for each of the ingredients included in the list of ingredients that are currently available to the cook, and adjusting the recipe in response to the best use dates for the ingredients.
